(19) United States
(12) Patent Application Publication
(10) Pub. No.: US 2009/0117992 A1
(43) Pub. Date: May 7, 2009

(54) DICE GAME AND METHOD THEREFOR

(76) Inventors: Hong Jansiri, Las Vegas, NV (US); Vincent Zaldivar, Las Vegas, NV (US)

Correspondence Address: WEISS & MOY PC, 4204 NORTH BROWN AVENUE, SCOTTSDALE, AZ, 85251, US

(21) Appl. No.: 11/935,577

(22) Filed: Nov. 6, 2007

(51) Int. Cl. A63F 9/04; A63F 13/00

(52) U.S. Cl. 463/22; 273/146; 463/25

(57) ABSTRACT

A dice game is disclosed. The dice game involves at least three dice, each side of each die bearing a different indicia and a display having single-indicium and multiple-indicia betting positions. A player may place a wager on a single indicium that may be rolled by any one of the dice and/or may place a wager on a combination of indicia that may be rolled by some or all of the dice.

### FIELD OF THE INVENTION

This invention relates generally to gaming and, more specifically, to a dice game.

### BACKGROUND OF THE INVENTION

In the game of roulette, a table has boxes for the numbers 1 through 36 arranged in three columns and 12 rows. Above the numbers 1, 2, and 3, are the boxes for 0 and 00. Numbers 1 through 36 are surrounded by either a red or black oval/rectangle. The 0 and 00 have green backgrounds. At one end of the table is the roulette wheel that has 38 numbered slots, each with the same colored background as the corresponding number on the table layout.

Each player is given a different color of chips so that the dealer can keep track of which chips belong to which player. Players place their bets by placing chips on the table layout. The dealer spins the wheel in one direction and spins a small, hard ball in the opposite direction around a track on the bowl-shaped recess that holds the wheel. When the speed of the ball decreases, it falls off the track toward the wheel and bounces around until it settles in a numbered slot. All winning bets are paid by the dealer and all losing bets are cleared from the table layout.

There are several types of bets that a player may make. “Inside bets” may be made by betting on single numbers, splitting between two numbers, betting on a street (i.e. three-numbers in a row), corner bets on four adjacent numbers, a five-number bet (i.e. betting on numbers 1, 2, 3, 0, 00), and a double street (i.e. betting on two consecutive three-number rows). “Outside bets” include betting on red or black, odd or even, and numbers 1 through 18 or 19 through 36. A player may also make an outside bet on dozens (i.e. the first twelve numbers, the second twelve, or the third twelve) and on columns (i.e. wagers on any of the three columns on the grid).

The game of craps is played with a set of two dice, with each die having six sides and wherein each side has 1, 2, 3, 4, 5, or 6 dots. The game is played by tossing the dice from one of the short ends of the table to the other, making sure that both die hit the opposite side wall of the table. Payoffs are made based on the number combination displayed on the top sides of the dice when they come to rest.

The basic idea is to roll the dice to establish a “point” number and to roll that number again before rolling a 7. Only the numbers 4, 5, 6, 8, 9, or 10 can be a point number and all other rolls on the dice have special meanings depending on when they are rolled (before or after a point is established).

Winning or losing depends on a variety of different possible outcomes of any roll of the two dice. The two dice can produce many different number combinations; some may be made several ways, others only one way. For example, two dice can roll the number 6 as follows: 5/1, 4/2, 3/3, 2/4, and 1/5. But the number 2 can only be rolled one way: 1/1. Numbers that can be rolled several ways, such as the number 6, do not pay as much as numbers which can be rolled only one way, unless you are betting that the number will be rolled in a specific way, such as 3/3, known as “hard ways.” All winning payoffs are determined by the frequency in which any two-dice number combinations can be rolled. Generally, the harder the combination is to roll, the more it will pay, and vice versa.

In the game of Roulette, the number of possible bets is fairly limited, as there is only one number chosen with each spin. And the game of Craps may be fairly complicated because the numerous possible bets. Therefore, a need existed for a new dice game that has more betting possibilities than Roulette and has more simplified betting strategies than Craps.

### SUMMARY OF THE INVENTION

It is an object of the present invention to provide a dice game that involves at least three dice, each side of each die bearing a different indicia and a display having single-indicium and multiple-indicia betting positions.

It is an object of the present invention to provide a dice game wherein a player may place a wager on a single indicium that may be rolled by any one of the dice.

It is another object of the present invention to provide a dice game wherein a player may place a wager on a combination of indicia that may be rolled by some or all of the dice.

It is another object of the present invention to provide a dice game wherein a player may place a wager on a category of indicia.

### BRIEF DESCRIPTION OF THE PREFERRED EMBODIMENTS

In accordance with one embodiment of the present invention, a method of playing a dice game is disclosed. The method comprises the steps of: providing at least three dice, each side of each die bearing an indicium, providing a display having a plurality of indicia positions, each indicia position being one of a single-indicium position having one indicium, and a multiple-indicia position having at least two indicia, selecting at least one indicia position by a least one player, rolling the at least three dice, and comparing the indicia shown on the at least three dice to the at least one indicia position selected by the at least one player.

In accordance with another embodiment of the present invention, a method of playing a dice game is disclosed. The dice game comprises the steps of: providing three dice, each side bearing one unique indicia, providing a display having a plurality of betting positions, each betting position being one of, a single-indicium betting position having one indicium, wherein there is one single-indicium betting position for each of the unique indicia, a double-indica betting position having two indicia, wherein there is one double-indicia betting position for each possible two-indicia combination of the unique indicia, and a triple-indicia betting position having three indicia, wherein there is one triple-indicia betting position for each possible three-indicia combination of the unique indicia, selecting at least one betting position by a player, placing a wager on the at least one betting position selected by the player, rolling the dice, and comparing the indicia shown on the dice to the at least one betting position selected by the player.

According to another embodiment of the present invention, a dice game is disclosed. The dice game comprises: three six-sided dice, each side of each die bearing one of six indicia and a display having a plurality of single-indicium betting positions, each having one indicium, wherein there is one single-indicium betting position for each of the six indicia, a plurality of double-indicia betting positions, each having two indicia, wherein there is one double-indicia betting position for each possible two-indicia combination of the six indicia, a plurality of triple-indicia betting positions, each having three indicia, wherein there is one triple-indicia betting position for each possible three-indicia combination of the six indicia, and a plurality of category betting positions, each category betting position having at least two of the six indicia.

The foregoing and other objects, features, and advantages of the present invention will be apparent from the following, more particular, description of the preferred embodiments of the invention, as illustrated in the accompanying drawings.

### BRIEF DESCRIPTION OF THE DRAWINGS

FIG. 1 is a top view of a display of the dice game of the present invention showing a plurality of betting positions.

FIG. 2 is a perspective view of a die of the dice game of the present invention, showing three different indicia, wherein the indicia are pictures.

FIG. 3 is a top view of each of the six indicia appearing on the die of FIG. 2.

FIG. 4 is a top view of three of the eighteen possible triple-indicia betting positions.

FIG. 5 is a perspective view of the dice game of the present invention.

FIG. 6 is a dice-rolling machine that may be used with the dice game of the present invention.

FIG. 7 is a side view of the dice-rolling machine of FIG. 6, with retractable bottom doors shown in phantom lines.

FIG. 8 is a perspective view of another embodiment of the dice game of the present invention.

### DETAILED DESCRIPTION OF THE PREFERRED EMBODIMENTS

The novel features believed characteristic of the invention are set forth in the appended claims. The invention will best be understood by reference to the following detailed description of illustrated embodiments when read in conjunction with the accompanying drawings, wherein like reference numerals and symbols represent like elements.

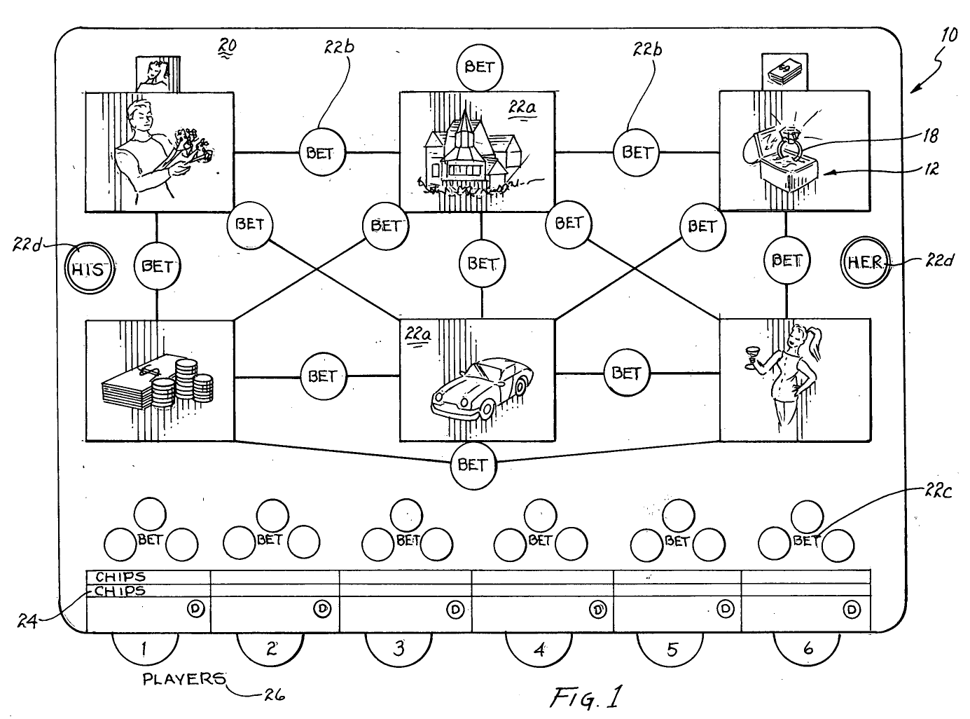

FIGS. 1-8 together disclose a dice game, hereinafter referred to as dice game 10. The dice game 10 preferably comprises a plurality of indicia 12, at least three dice 14, each side 16 of each die 14 bearing one of the plurality of indicia 12, and a display 20 of a plurality of indicium positions.

Referring to FIG. 1, one embodiment of the display 20 of the dice game 10 is shown. In this embodiment, there are six possible indicia 12. In FIG. 1, the six indicia 12 are pictures 18 of a man, a woman, a diamond ring, a sports car, a stack of cash, and a mansion. The indicia 12 for the dice game 10 of the present invention should not be limited to those shown in FIG. 1. It should be clearly understood that further substantial benefit may be derived from the indicia 12 being letters, numbers, symbols, characters, or any other suitable indicia 12. It should also be understood that where the indicia 12 are pictures 18, the pictures 18 may be of any animals, people, places, or objects and they are not limited to those pictures 18 shown in FIG. 1.

In the embodiment shown in FIG. 1, players 26 are able to place wagers on the indicia positions, thus making them betting positions 22. The display 20 has single-indicium betting positions 22a (referred to generically as betting position 22), double-indicia betting positions 22b (referred to generically as betting position 22), and triple-indicia betting positions 22c (referred to generically as betting position 22). A single-indicium betting position 22a bears only one indicium 12, a double-indicia betting position 22b bears two indicium 12, and a triple-indicia betting position 22c bears three indicia 12. While it is shown that there are betting positions 22 for only up to three indicia 12, it should be clearly understood that substantial benefit may be derived from additional betting positions 22 for combinations of more than three indicia 12 (e.g. betting positions having four indicia, five indicia, etc.).

The number of possible indicia combinations would depend on the number of indicia 12 being used in the dice game 10. For example, if three dice 14 were being used, there would be more possible indicia combinations if the dice 14 are eight-sided than there would be if the dice 14 are six-sided. Furthermore, the number of indicia 12 in the indicia combinations themselves would at most be equal to the number of dice 14. For example, if four dice 14 were being used, the display 20 could also have four-indicia betting positions (in addition to single-indicium betting positions 22a, double-indicia betting positions 22b, and triple-indicia 22c betting positions).

In the embodiment shown in FIG. 1, the display 20 has six single-indicium betting positions 22a, one for each of the six different indicia 12; fifteen double-indicium betting positions 22b, one for each of the fifteen possible two-indicia combinations; and twenty triple-indicia betting positions 22c, one for each of the twenty possible triple-indicia combinations.

For additional possible betting positions 22, the indicia 12 may be divided or apportioned into separate categories. For example, the ring, the woman, and the mansion may belong to a “her” category while the car, the man, and the cash may belong to a “his” category. Therefore, as shown in FIG. 1, there may be two separate category betting positions 22d (referred to generically as betting position 22), one for “his” and one for “her.” In this case, the number of triple-indicia betting positions 22c would be adjusted to eighteen, rather than twenty.

While only two category positions 22d are shown, it should be clearly understood that more than one category of indicia 12 may be created. For example, there could be three category betting positions 22d, each having two of the six indicia 12. In that case, the number of double-indicia betting positions 22b would adjusted to twelve, rather than fifteen. And where there are more than six indicia 12, because of the dice 14 having more than six sides 16, there may be more than three category betting positions 22d available.

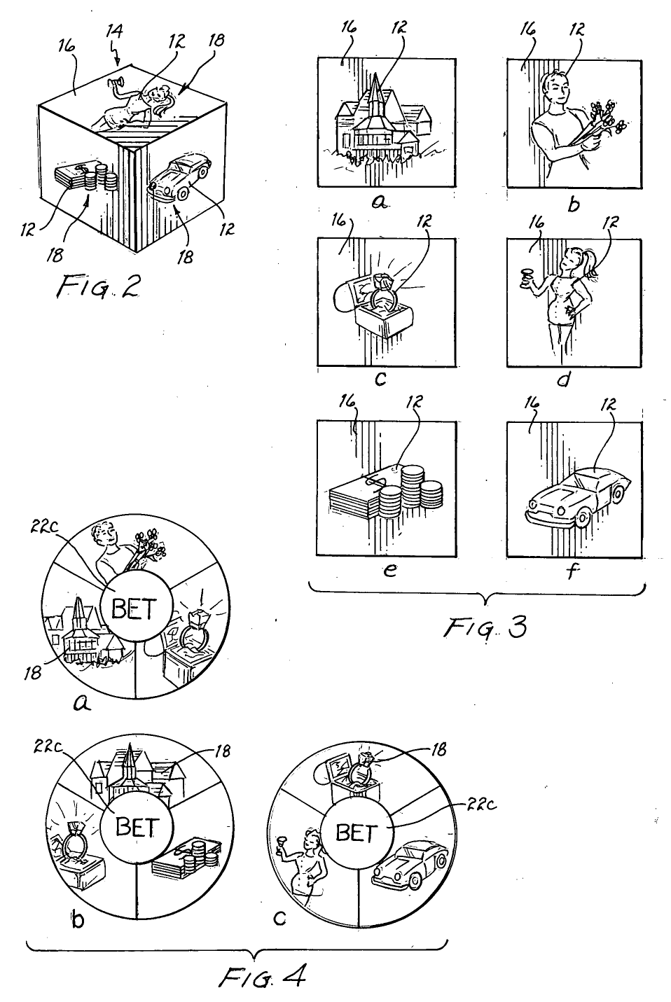

Referring now to FIGS. 2 and 3, one embodiment of a die 14 is shown. In FIG. 2, one die 14 is shown bearing three of the pictures 18 shown in the display 20 of FIG. 1. In this embodiment, each die 14 has six sides 16 and, as shown in FIG. 3, each side 16 bears one of the six pictures 18 (a man, a woman, a diamond ring, a sports car, a stack of cash, and a mansion). It should be clearly understood, however, that substantial benefit may be derived from using dice 14 having more than six sides 16 and thus bearing more than six indicia 12. Having more sides 16 on the dice 14 and having more indicia 12 would increase the possible indicia combinations and possible betting positions 22.

FIG. 4 shows some examples of triple-indicia betting positions 22c. While the betting positions 22c show the actual indicia 12, it should be clearly understood that substantial benefit may be derived from the betting positions 22c identifying the indicia 12 by name. For example, instead of the betting position 22c showing the pictures 18 of a mansion, a diamond ring, and a stack of cash, the betting position 22c may simply have the words “mansion,” “diamond ring,” and “cash.” This may also apply to the single-indicia betting positions 22a and double-indicia betting positions 22b, as well as any other available betting position 22.

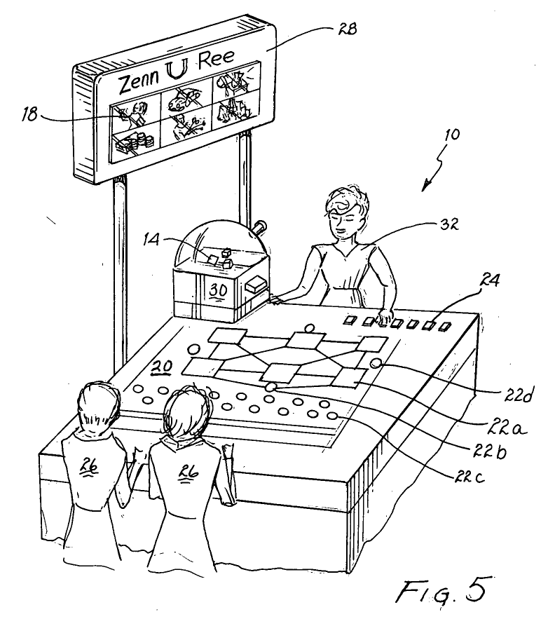

FIG. 5 shows an embodiment of the dice game 10 of the present invention. If the dice game 10 were to be played in a casino setting, there would preferably be a dealer 32 to manage the wagers and payouts. Preferably, a player 26 will place a wager with colored chips 24 that are assigned a monetary value. Where there are multiple players 26, it is preferred that each player 26 be assigned a different color of chips 24. This will help to distinguish which wagers were made by which players 26. It is preferred that the wagers may be placed by the players 26 themselves; however, it should be clearly understood that substantial benefit may be derived from the dealer 32 placing the wagers for the players 26.

Also shown in FIG. 5 is a lighted sign 28. The lighted sign 28 will preferably show each of the available indicia 12 of the dice game 10. After each roll of the dice 14, the lighted sign 28 will display which of the indicia 12 were rolled. This will help players 26 to clearly see which indicia 12 were rolled. This will also help to attract the attention of on-lookers and passers-by. It should be clearly understood, however, that substantial benefit may still be derived from a dice game 10 that does not use a lighted sign 28.

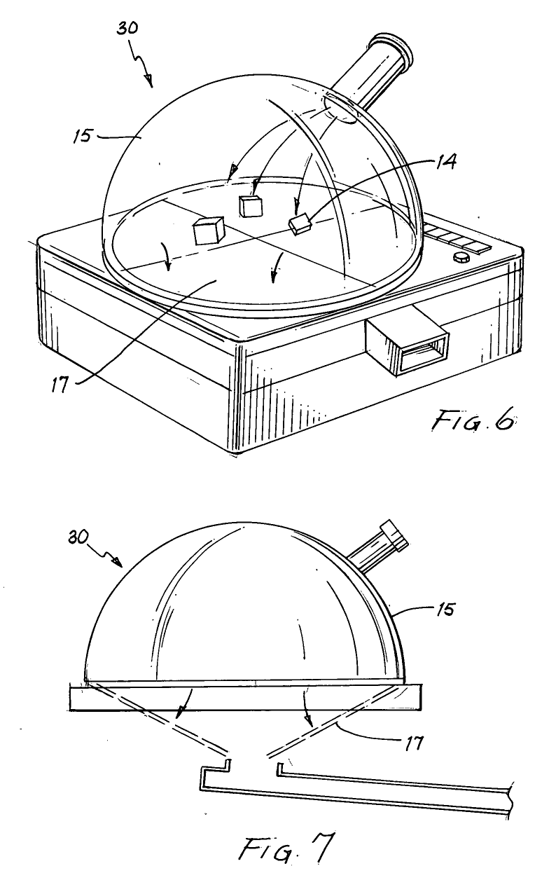

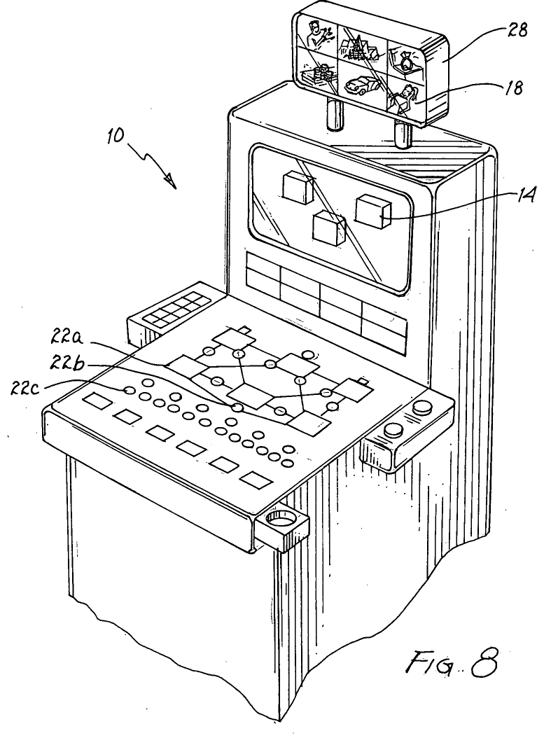

The dice game 10 may also have a dice-rolling machine 30. However, it should be clearly understood that substantial benefit may be derived from the players 26 rolling the dice 14 or from the dealer 32 rolling the dice 14 manually. The dice-rolling machine 30 will preferably be operated by the dealer 32. As shown in FIGS. 6 and 7, the dice 14 are contained within a housing 15. Preferably, the dice-rolling machine 30 will drop the dice 14 onto a retractable flat surface 17 and when it is time for the dice 14 to be rolled again, the dice 14 will preferably descend through the retracted flat surface 17 and back through the dice-rolling machine 30 to be rolled again onto the flat surface 17.

Referring to FIG. 8, another embodiment of the dice game 10 is shown. In this embodiment, the game 10 is in electronic form. This allows a player 26 to play the dice game 10 without others playing alongside. In this format, the dice 14 are “rolled” electronically and the wagers are made electronically as well. It should also be understood that substantial benefit may be derived from the dice game 10 being in a board game format.

### Statement of Operation

In order to play the dice game 10, a player 26 will be provided with dice 14. In one embodiment, the player 26 will be provided with three dice 14, and each of the dice 14 is six-sided. It should be clearly understood that substantial benefit may be derived from the player 26 being given a different number of dice 14 and from the dice 14 having a different number of sides 16, but is it is preferred that the player 26 be given at least three dice 14 and that the dice 14 have at least six sides 16.

The player 26 will view the display 20 that has a plurality of betting positions 22. In the embodiment shown in FIG. 1, the player 26 will select as many single-indicium betting positions 22a, double-indicia betting positions 22b, and triple-indicia betting positions 22c as the player 26 wishes. The player 26 will then roll the dice 14 and will compare the three pictures 18 shown on the three dice 14 to the picture(s) 18 on the betting position(s) 22 that the player 26 had previously selected.

If played in a casino, the player 26 would be given chips 24 with which to place a wager on the betting position(s) 22 that the player 26 selected. For example, a player 26 may place a wager on a single-indicium betting position 22a bearing the picture 18 of a car, another wager on a double-indicia betting position 22b bearing the pictures 18 of a car and a mansion, and yet another wager on a triple-indicia betting position 22c bearing the pictures 18 of a diamond ring, a woman, and a man. If the dice 14 have been rolled and the dice 14 show a car, another car, and a mansion, the player 26 will receive a payout on the single-indicium betting position 22a bearing the picture 18 of a car (e.g. 1:1) and the player 26 will also receive a payout on the double-indicia betting position 22b bearing the pictures 18 of a car and a mansion (e.g. 2:1).

The casino may also offer a higher payout on the single-indicium betting position 22a bearing the picture 18 of the car because the car was shown on two of the dice 14 (e.g. 2:1). It therefore follows that the casino may also offer an even higher payout on the single-indicium betting position 22a bearing the picture 18 of the car if the car was shown on all three of the dice 14 (e.g. 19:1). If more than three dice 14 are used, the casino may offer even higher payouts on single-indicium betting positions 22a, depending of course on how many of the dice 14 show the one indicium 12 of the single-indicium betting position 22a.

Similarly, the casino may offer a higher payout on the double-indicia betting position 22b bearing the pictures 18 of the car and the mansion because one indicia of the two-indicia combination (i.e. the car) was shown on two of the three dice 14 (e.g. 4:1). And, if more than three dice 14 are used, the casino may offer even higher payouts on double-indicium betting positions 22b, depending of course on how many of the dice 14 show one or both of the indicia of the two-indicia combination of the double-indicium betting position 22b.

The player's 26 wager on the triple-indicia betting position 22c bearing the pictures 18 of a ring, a woman, and a man will be lost. The payouts for each of these betting positions 22 will be predetermined by the casino.

Preferably, the payout schedule from smallest to largest will be single-indicium betting position 22a, double-indicia betting position 22b, and triple-indicia betting position 22c. As an example, the payout for a single-indicium betting position 22a may be 1:1, the payout on a double-indicia betting position 22b may be 2:1, and the payout for a triple-indicia betting position may be 3:1. However, it should be clearly understood that any payout schedule may be acceptable.

The player 26 may also select and place a wager on a category betting position 22d. The categories and the indicia 12 belonging to those categories will be predetermined. As an example, the mansion, the diamond ring, and the woman may be designated to belong to a “her” category and the sports car, the stack of cash, and the man may be designated to belong to a “his” category. If the player 26 places a wager on the “her” category betting position 22d and the rolled dice 14 show a mansion, a diamond ring, and a woman, the player 26 will receive a payout for the wager he/she placed on that category betting position 22d. If the rolled dice 14 showed a diamond ring, a woman, and a car, the player 26 would lose his/her wager. Preferably, the payout for a category betting position 22d would be higher than a triple-indicia betting position 22c. As an example, the payout for a category betting position 22d may be 25:1, but it should be clearly understood that any payout schedule may be acceptable for this type of wager.

After all winning wagers have been paid out and all losing wagers have been collected, the game will start again.

While the invention has been particularly shown and described with reference to preferred embodiments thereof, it will be understood by those skilled in the art that the foregoing and other changes in form and details may be made therein without departing from the spirit and scope of the invention. For example, all payout schedules mentioned above should be understood to be exemplary only and that substantial benefit may be derived from any payout schedule being used.

What is claimed is:

1. A method of playing a dice game comprising the steps of:
providing at least three dice, each side of each die bearing an indicium;
providing a display having a plurality of indicia positions, each indicia position being one of:
a single-indicium position having one indicium; and
a multiple-indicia position having at least two indicia;
selecting at least one indica position by a least one player;
rolling the at least three dice; and
comparing the indicia shown on the at least three dice to the at least one indicia position selected by the at least one player.

2. The method of claim 1 further comprising the step of placing a wager by the at least one player on the at least one indicia position selected by the at least one player.

3. The method of claim 2 wherein placing the wager comprises the step of placing at least one chip on the at least one indicia position selected by the at least one player, the at least one chip being assigned a predetermined money value.

4. The method of claim 3 further comprising the step of assigning the at least one player a unique chip color.

5. The method of claim 1 wherein the at least three dice are electronically generated.

6. The method of claim 1 wherein the at least three dice are each six-sided, each side bearing one of six unique indicia.

7. The method of claim 1 wherein the multiple indicia position has at most a number of indicia equal to the number of dice.

8. The method of claim 2 further comprising the steps of:
selecting at least one single-indicium position by the at least one player;
placing a wager on the at least one single-indicium position selected by the at least one player;
showing the one indicium of the at least one single-indicium position selected by the at least one player on at least one of the at least three dice; and
receiving by the at least one player a predetermined payout for the wager.

9. The method of claim 8 wherein the amount of the payout depends upon how many of the at least three dice show the one indicium of the at least one single-indicium position selected by the at least one player.

10. The method of claim 2 further comprising the steps of:
selecting at least one multiple-indicia position by the at least one player;
placing a wager on the at least one multiple-indicia position selected by the at least one player;
showing all of the at least two indicia of the at least one multiple-indicia position selected by the at least one player on at least two of the at least three dice; and
receiving by the at least one player a predetermined payout for the wager.

11. The method of claim 10 wherein the amount of the payout depends upon how many of the at least three dice show the at least two indicia of the at least one multiple-indicia position selected by the at least one player.

12. A method of playing a dice game comprising the steps of:
providing three dice, each side bearing one unique indicia;
providing a display having a plurality of betting positions, each betting position being one of:
a single-indicium betting position having one indicium, wherein there is one single-indicium betting position for each of the unique indicia;
a double-indicia betting position having two indicia, wherein there is one double-indicia betting position for each possible two-indicia combination of the unique indicia; and
a triple-Indicia betting position having three indicia, wherein there is one triple-indicia betting position for each possible three-indicia combination of the unique indicia;
selecting at least one betting position by a player;
placing a wager on the at least one betting position selected by the player;
rolling the dice; and
comparing the indicia shown on the dice to the at least one betting position selected by the player.

13. The method of claim 12 further comprising the steps of:
grouping the unique indicia into at least two different categories, each category comprising at least two of the unique indicia;
providing a display having at least two category betting positions, wherein there is one category betting position for each category.

14. The method of claim 12 further comprising the steps of:
selecting by the player a single-indicium betting position;
placing a wager by the player on the single-indicium betting position selected by the player;
determining that the one indicium of the single-indicium betting position is shown on at least one of the dice; and
paying the player a predetermined payout for the wager.

15. The method of claim 14 further comprising the step of paying the player a higher predetermined payout when the one indicium of the single-indicium betting position is shown on more than one of the dice.

16. The method of claim 12 further comprising the steps of:
selecting by the player a double-indicia betting position;
placing the wager by the player on the double-indicia betting position selected by the player;
determining that the two indicia of the double-indicia betting position are shown on at least two of the dice;
paying the player a predetermined payout for the wager.

17. The method of claim 16 further comprising the step of paying the player a higher predetermined payout when one of the two indicia of the double-indicia betting position is shown on two of the dice.

18. The method of claim 12 further comprising the steps of:
selecting by the player a triple-indicia betting position;
placing the wager by the player on the triple-indicia betting position selected by the player;
determining that the three indicia of the triple-indicia betting position are shown on the three dice;
paying the player a predetermined payout for the wager.

19. The method of claim 13 further comprising the steps of:
selecting by the player a category betting position;
placing the wager by the player on the category betting position selected by the player;
determining that the indicia shown on the three dice belong to the category of the category betting position; and
paying the player a predetermined payout for the wager.

20. A dice game comprising:
three six-sided dice, each side of each die bearing one of six indicia; and
a display having:
a plurality of single-indicium betting positions, each having one indicium, wherein there is one single-indicium betting position for each of the six indicia;
a plurality of double-indicia betting positions, each having two indicia, wherein there is one double-indicia betting position for each possible two-indicia combination of the six indicia;
a plurality of triple-indicia betting positions, each having three indicia, wherein there is one triple-indicia betting position for each possible three-indicia combination of the six indicia; and
a plurality of category betting positions, each category betting position having at least two of the six indicia.

21. The dice game of claim 20 further comprising a plurality of chips for placing wagers by at least one player on at least one betting position, wherein each player is given a unique color of chips.

22. The game of claim 20 further comprising a dice-rolling machine.
